(19) United States
(12) Patent Application Publication
(10) Pub. No.: US 2005/0193267 A1
(43) Pub. Date: Sep. 1, 2005

(54) Application program sharing framework and method for operating systems

(76) Inventors: Eldon Liu, Taipei (TW); Alex Wu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/023,450

(22) Filed: Dec. 29, 2004

(30) Foreign Application Priority Data
Jan. 30, 2004 (TW) 093102237

(51) Int. Cl. G06F 11/00

(52) U.S. Cl. 714/38

(57) ABSTRACT

An application program sharing framework and method includes an Basic input/output system for issuing the starting command of a second operating system which consuming fewer system resources, an application program executed in an environment of the second operating system, and an interface for transforming the data parameter and the parameter of the multimedia playing program in the first operating system into the executable format of the second operating system. Accordingly, the waiting time for starting the first operating system and the resource consuming will be reduced, and the resource sharing, re-installation avoidance and storage-saving can be achieved as well.

### BACKGROUND OF THE INVENTION

1. Field of Invention

The invention relates to an application program sharing framework and method for operating systems and, in particular, it provides an interface for transforming at least one data parameter and a multimedia playing program between dual operating systems.

2. Related Art

For the facilitation of using computer, the operating system provides a uniform logical way, which is the file for data storing, and the file system is established in the partition of the storage for storing files. One of the file system techniques is the file allocation table (FAT) for recording all the addresses of the hard disk. The DOS operating system searches the available address while creating a file, and then marks the address “used”. That is, FAT is an area for recording the clusters status of the hard disk, and it is restricted to the 8.3 naming rule for file naming. Hence, the FAT formatted file lacks of the protection recovery, and the sufficient addressing abilities. Furthermore, the Linux operating system is less popular and compatible than the Microsoft Windows, and there exists the NTFS Microsoft for aiding with FAT, which having the compatibility for multiple operating system, fault tolerance for supporting multiple disk accessing methods, and providing parity check, error recovery, and speedup, security for authorizing and controlling the authority for accessing directories and files of the local and remote host, and so on.

Besides, Linux operating system taking “ext2” to be a primary file system, which is established in the partition of the storage. Before accessing the files, it's required for mounting them to the nodes of the directory tree of the file system, and then amounting them from the directory tree when finishing related operation. Moreover, kernel of the Linux supports various file system, such as ex2, file system of BSD platform and Microsoft, and it provides a uniform interface by a virtual file system for maintaining operating way, at least one of the application programs should be re-installed in the two operating system, which results in the waste of storage and locking of the resource sharing.

In order to provide the compatibility of the Linux and Windows, “Wine”, a simulation program, is proposed for simulating the Window operating system in the Linux environment. Wine can executing the software program in the MS-DOS, Window 3.x, and the Win 32 operating system, and it is valid even when the application calls for the interrupt service routines as well. Hence, Wine can load external DLL file, support multimedia functions such as GDI 32 and Direct X, covert the application program of the Windows into documents of postscript format of Unix operating system for printing by a printer. However, since the Wine is just a simulation program, the performing speed is still lower than that of Windows.

Since the demands arose from the virus defense, system management, and stability, the loading and system resource consuming arising continuously. When an end user performs an application program, the longer waiting time for file starting up results in the time cost arising.

### SUMMARY OF THE INVENTION

In view of the foregoing, the invention is to provide an application program sharing framework and method for operating systems, herein it includes an application program for executing in the environment of a second operating system, and an interface for transforming at least one data parameter and a multimedia playing program of the first operating system into executable format of the second operating system for sharing the data parameter and the multimedia playing program.

In addition, the framework and method of the present invention transform the data parameter for sharing the multimedia playing program of the first operating system with the second operating system which issuing a transform command in an interface.

Besides, the system portability can be ensured since the second operating system is installed in a second storage whose size is smaller than a first storage.

Moreover, the present invention is storage-saving since the re-installation of the application program is avoided.

Furthermore, the present invention is power-saving since only the resource of the multimedia required is started.

In view of the foregoing, the application program sharing framework and method includes an basic input/output system for managing and controlling the boot setting of a host, a first operating system for providing an executing environment, a second operating system installed in a second storage which has smaller size than the first storage for portability, an application program for issuing the executing command for the data parameter of the second operating system, and an interface for transforming the data parameter and the parameter of the multimedia playing program to the executable format of the second operating system. Accordingly, the end user starts up the operating system which occupying fewer resource through the basic input/output system, and the application program issues the data parameter accessing and transforming commands in the interface and the second operating system for sharing the resource of the first operating system. Hence, the waiting time for starting the second operating system and the resource consuming will be reduced, and the portability, resource sharing and storage-saving can be achieved as well.

### BRIEF DESCRIPTION OF THE DRAWINGS

The invention will become more fully understood from the detailed description given herein below illustration only, and thus is not limitative of the present invention, and wherein:

FIG. 1 is a block diagram according to a preferred embodiment of the application program sharing of the invention.

FIG. 2 is a block diagram according to a preferred embodiment of the data parameter sharing of the invention.

FIG. 3 is a block diagram according to another preferred embodiment of the application program sharing of the invention.

FIG. 4 is a schematic view according to another preferred embodiment of the data parameter sharing of the invention.

FIG. 5 is a flow chart showing the steps according to the other preferred embodiment of the application program sharing of the invention.

### DETAILED DESCRIPTION OF THE INVENTION

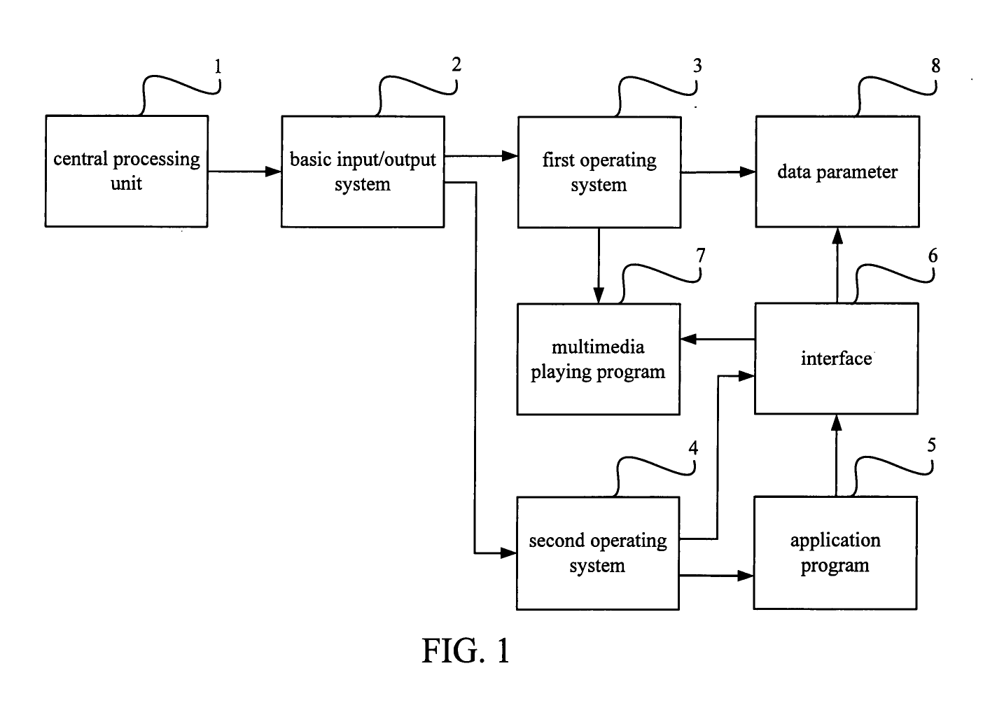

With reference to FIG. 1, the system includes a CPU 1, an basic input/output system 2 for managing and controlling the boot setting procedure of a host, a first operating system 3 for executing multiple programs concurrently, a second operating system 4 for executing at least one program, an application program 5 executing in the environment of the second operating system 4, an interface 6 for transforming a multimedia playing program 7 and at least one data parameter 8 into an executable format of the second operating system 4, the multimedia playing program 7 installed in the first operating system 3 for playing at least one audio/video data of the DVD or VCD , and the data parameter 8 recorded in a file system of the first operating system 3.

Moreover, the first operating system 3 provides a file format of FAT or NTFS, and it can be the windows XP, Windows NT, Window 98, Windows 2000, Windows Me, and so on. The second operating system 4 provides a file format of EXT 2 or EXT 3, and it can be the Linux operating system. Therefore, the end user starts up the second operating system 4 which occupying fewer resource through the basic input/output system 2, and the application program 5 issues the data parameter accessing and transforming commands to the interface 6. the interface 6 transfroms the related parameters of the data parameter and the multimedia playing program to allow the second operating system 4 to sharing the resource of the first operating system 3.

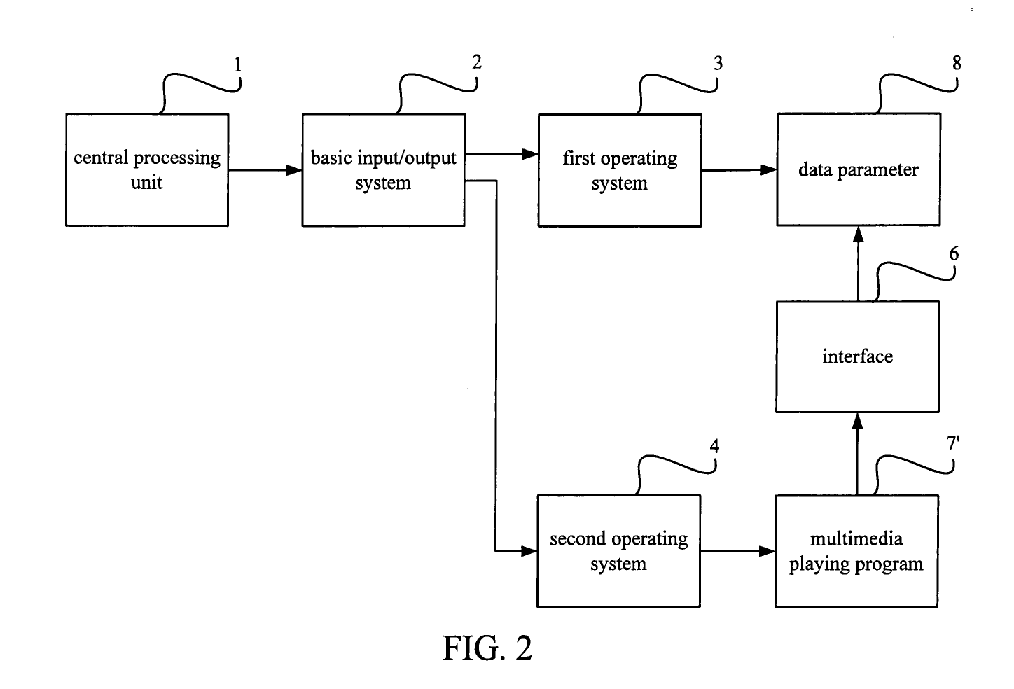

With reference to FIG. 2, the multimedia playing program 7′ installed in the second operating system 4 for playing the audio/video data of the DVD or VCD. An end user starts up the second operating system 4 through the basic input/output system 2, and executing the multimedia playing program 7′. Once the multimedia playing program 7′ is executed, it issues a command for transforming a data parameter 8 into the executable format of the multimedia playing program 7′ of the second operating system 4.

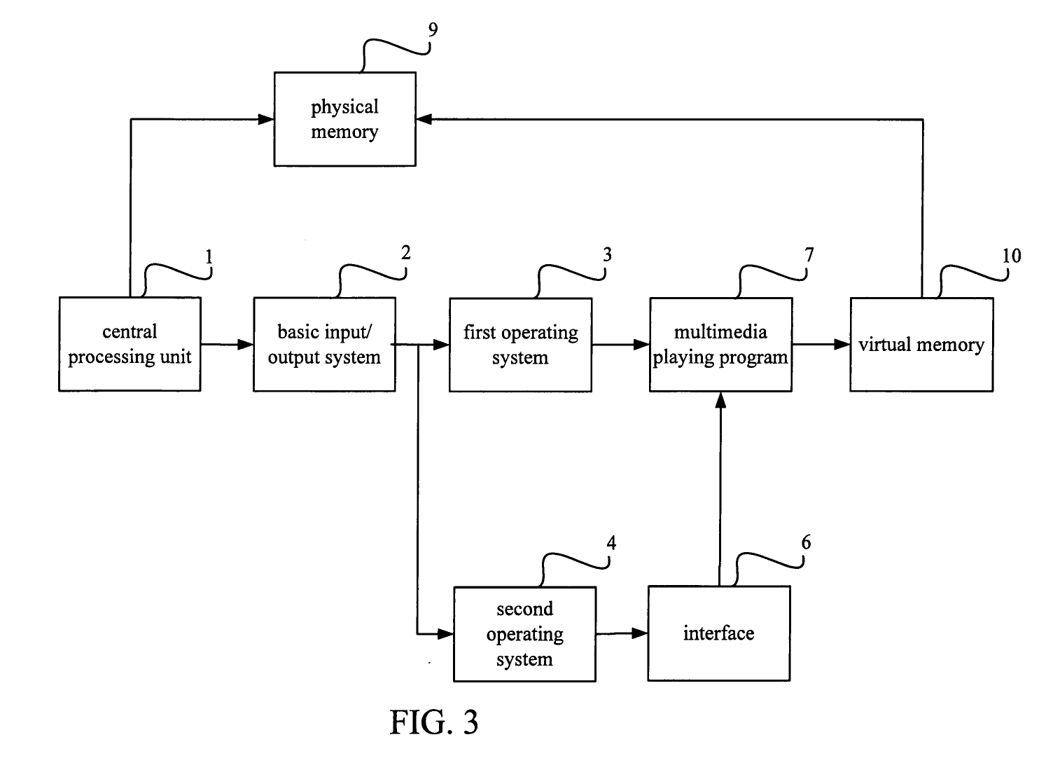

With reference to FIG. 3, the system includes a first storage for storing the first operating system 3, a second storage for storing the second operating system 4, a multimedia playing program 7 installed in the first operating system 3, an interface 6 for transforming the data parameter of the multimedia playing program 7 into the executable format of the second operating system 4, a physical memory 9 for storing required data for executing, and a virtual memory 10 as a complement of the physical memory 9. In addition, when the multimedia playing program 7 is loaded in the virtual memory 10 and the executed, the virtual memory 10 provides required data for the multimedia playing program 7, and after completing the execution in the physical memory 9, the data parameter of the multimedia playing program 7 will be transformed to the executable format of the first operating system 3 through the interface 6. Moreover the first storage can be a hard disk or a read-only memory, whereas the second storage can be a hard disk, a read-only memory, and a hard disk with the universal serial bus interface. Hence, the hard disk with the universal serial bus interface which stores the second operating system 4 can be used in any host with a slot, and the basic input/output system 2 is customized started in the second operating system 4 which stores in the hard disk with the universal serial bus for sharing the multimedia playing program 7 of the first operating system 3.

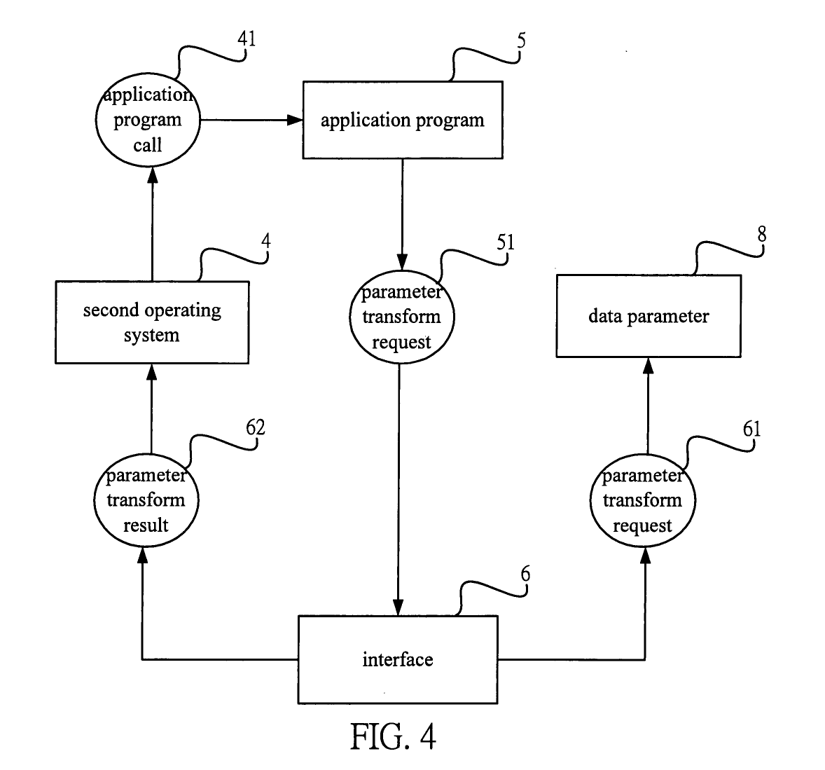

With reference to FIG. 4, an end user issues an application program call 41 to an application program 5, and then the application program 5 issues a parameter transform request 51 to the interface 6. The interface 6 stores the data parameter 8 in the executable parameter of the first operating system 3 through a parameter transform request 61, transforms the data parameter 8 to the executable format of the second operating system 4, returns the parameter transform result 62 to the second operating system 4, and transforms the data parameter to the executable format of the first operating system 3 for data parameter sharing through the parameter transform request 61.

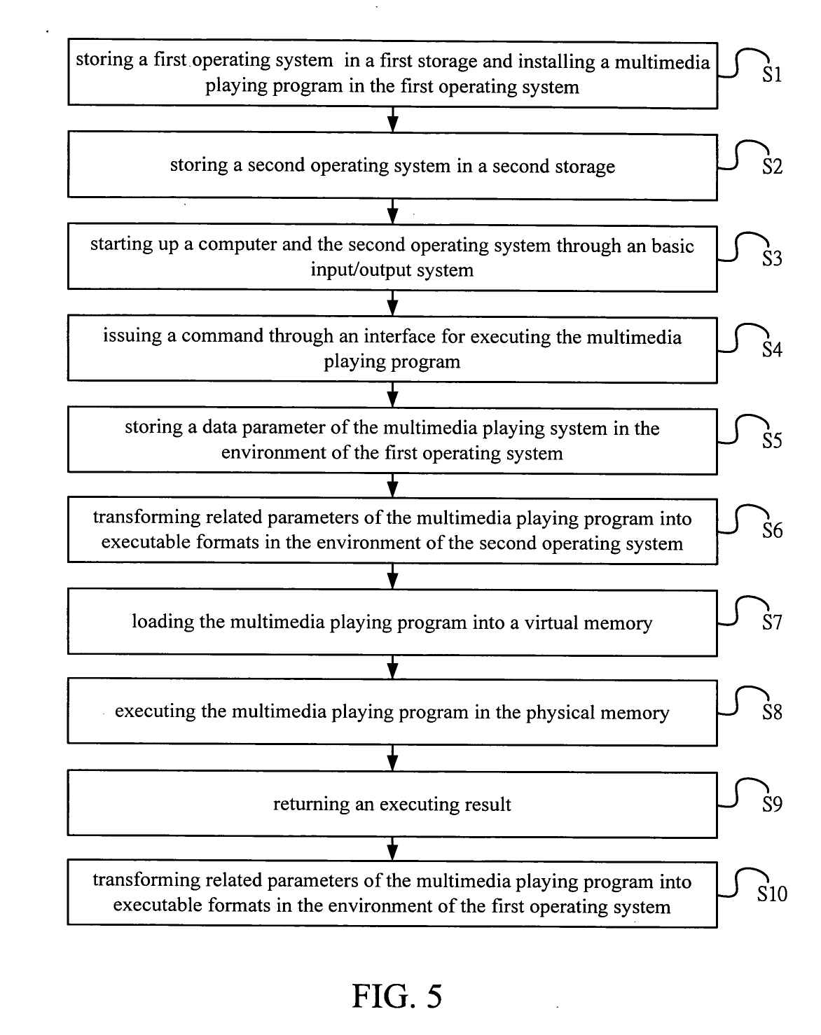

With reference to FIG. 5, the method of the present invention includes the steps of storing a first operating system in a first storage and installing a multimedia playing program in the first operating system in step S1; storing a second operating system in a second storage in step S2; starting up a computer and the second operating system through an basic input/output system in step S3; issuing a command through an interface for executing the multimedia playing program in step S4; storing a data parameter of the multimedia playing system in the environment of the first operating system in step S5; transforming related parameters of the multimedia playing program into executable formats in the environment of the second operating system in step S6; loading the multimedia playing program into a virtual memory in step S7; executing the multimedia playing program in the physical memory in step S8; returning an executing result in step S9; and transforming related parameters of the multimedia playing program into executable formats in the environment of the first operating system in step S10.

As mentioned above, the application program sharing framework and method of the invention includes a first operating system, at least one data parameter and a multimedia playing program installed in a first storage, a second operating system installed in a second storage which has smaller size than the first storage for portability, an application program for executing in the environment of the second operating system, an interface for transforming the data parameter and the parameter of the multimedia playing program into the executable format of the second operating system, a physical memory for storing the required data for executing, and a virtual memory as a complement of the physical memory. The end user thus starts up the second operating system which occupying fewer resource than the first operating system through the basic input/output system, issues the data parameter accessing and transforming commands to the interface for transforming the data parameter. Therefore, by loading the multimedia playing program requiring more resources into the virtual memory and then retrieving it to the physical memory during executing, the storing-saving and the avoidance of application program re-installation can be achieved.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. An application program sharing framework for operating systems, the framework comprising:
a first operating system;
a second operating system;
at least one data parameter recorded in a file system of the first operating system;
an application program executed in an environment of the second operating system; and
an interface for transforming the data parameter between the first operating system and the second operating system;
wherein the application program can share the data parameter in the environment of the second operating system through the interface.

2. The framework of claim 1, further comprising:
a first storage which is a hard disk for storing the first operating system.

3. The framework of claim 2, wherein the first storage is a related storage.

4. The framework of claim 3, wherein the related storage is a read-only memory.

5. The framework of claim 1, further comprising: a second storage which is a hard disk with universal serial bus interface for storing the second operating system.

6. The framework of claim 5, wherein the second storage is a read-only memory.

7. The framework of claim 5, wherein the second storage is a related storage.

8. The framework of claim 7, wherein the related storage is a hard disk.

9. An application program sharing method for operating systems, the method comprising:
providing a first operating system and a second operating system;
providing at least one data parameter in a file system of the first operating system;
providing an application program in an executing environment of the second operating system;
executing the application program in the executing environment of the second operating system; and
transforming the data parameter through an interface to allow the application program to share the data parameter.

10. The method of claim 9, further comprising:
storing the first operating system in a first storage which is a hard disk.

11. The method of claim 10, wherein the first storage is a related storage.

12. The method of claim 11, wherein the related storage is a read-only memory.

13. The method of claim 9, further comprising:
storing the second operating system in a second storage which is a hard disk with universal serial bus interface.

14. The method of claim 13, wherein the second storage is a related storage.

15. The method of claim 14, wherein the related storage is a read-only memory.

16. The method of claim 14, wherein the related storage is a hard disk.

17. An application program sharing framework for operating systems, the framework comprising:
a first operating system;
a second operating system;
a multimedia playing program executing in a environment of the first operating system for playing at least one audio/video data; and
an interface for transforming the multimedia playing program between the first operating system and the second operating system;
wherein the second operating system sharing the multimedia playing program by using the interface to transform a data parameter of the multimedia playing program.

18. The framework of claim 17, further comprising:
a first storage which is a hard disk for storing the first operating system.

19. The framework of claim 18, wherein the first storage is a related storage.

20. The framework of claim 19, wherein the related storage is a read-only memory.

21. The framework of claim 17, further comprising:
a second storage which is a hard disk with universal serial bus interface for storing the second operating system.

22. The framework of claim 21, wherein the second storage is a read-only memory.

23. The framework of claim 21, wherein the second storage is a related storage.

24. The framework of claim 23, wherein the related storage is a hard disk.

25. An application program sharing method for operating system, the method comprising:
providing a first operating system and a second operating system;
providing a multimedia playing program in an executing environment of the first operating system;
transforming a data parameter of the multimedia playing program through an interface to allow the second operating system to share the multimedia playing program; and
executing the multimedia playing program in the executing environment of the second operating system.

26. The method of claim 25, further comprising: storing the first operating system in a first storage which is a hard disk.

27. The method of claim 26, wherein the related storage is a related storage.

28. The method of claim 27, wherein the related storage is read-only memory.

29. The method of claim 25, further comprising:
storing the second operating system in a second storage which is a hard disk with universal serial bus interface.

30. The method of claim 29, wherein the second storage is a related storage.

31. The method of claim 30, wherein the related storage is a read-only memory.

32. The method of claim 30, wherein the related storage is a hard disk.

33. An application program sharing framework, the framework comprising:
a first operating system;
a second operating system;
at least one data parameter for recording in a file system of the first operating system;
a multimedia playing program executing in an environment of the second operating system for playing at least one audio/video data; and
an interface for transforming the data parameter between the first operating system and the second operating system;
wherein the multimedia playing program sharing the data parameter by using the interface to transform the data parameter of the first operating system.

34. The framework of claim 33, further comprising:
a first storage which is a hard disk for storing the first operating system.

35. The framework of claim 34, wherein the first storage is a related storage.

36. The framework of claim 35, wherein the related storage is a read-only memory.

37. The framework of claim 33, further comprising:
a second storage which is a hard disk with universal serial bus interface for storing the second operating system.

38. The framework of claim 37, wherein the storage is a read-only memory.

39. The framework of claim 37, wherein the storage is a related storage.

40. The framework of claim 39, wherein the related storage is a hard disk.

41. An application program sharing method for operating systems, the method comprising:
providing a first operating system and a second operating system; providing at least one data parameter in a file system of the first operating system;
providing a multimedia playing program in an executing environment of the second operating system;
executing the multimedia playing program in the executing environment of the second operating system; and
transforming the data parameter through an interface to allow the multimedia playing program to share the data parameter of the first operating system.

42. The method of claim 41, further comprising: a first storage which is a hard disk for storing the first operating system.

43. The method of claim 42, wherein the first storage is a related storage.

44. The method of claim 43, wherein the related storage is a read-only memory.

45. The method of claim 41, further comprising:
a second storage which is a hard disk with universal serial bus interface for storing the second operating system.

46. The method of claim 45, wherein the second storage is a related storage.

47. The method of claim 46, wherein the related storage is a read-only memory.

48. The method of claim 46, wherein the related storage is a hard disk.
